(19) United States
(12) Patent Application Publication
(10) Pub. No.: US 2013/0281240 A1
(43) Pub. Date: Oct. 24, 2013

(54) TRANSVERSE ELEMENT WITH A PROTRUDING CONICAL STUD FOR A DRIVE BELT

(71) Applicant: Cornelis Johannes Maria Van Der Meer, Tilburg (NL)

(72) Inventor: Cornelis Johannes Maria Van Der Meer, Tilburg (NL)

(73) Assignee: Robert Bosch GmbH, Stuttgart (DE)

(21) Appl. No.: 13/976,597

(22) PCT Filed: Dec. 22, 2011
(86) PCT No.: PCT/NL11/00085

§ 371 Date: Jun. 27, 2013

(30) Foreign Application Priority Data
Dec. 28, 2010 (NL) 1038481

(51) Int. Cl. F16G 5/16

(52) U.S. Cl. CPC F16G 5/16
USPC 474/244

(57) ABSTRACT

Transverse element (32) for a drive belt with an endless carrier and with a number of such transverse elements (32) with a longitudinally protruding conical hole (41) and with a longitudinally protruding conical stud (40) provided on respective main faces (38, 39) of the transverse element (32). Both the conical stud (40) and the conical hole (41) are designed with a cone angle of at least 20 degrees.

The present invention relates to a drive belt for a continuously variable transmission with two variable diameter pulleys, in particular for a motor vehicle, as defined in the preamble of claim 1.

Such a belt is generally known in the art, for example from the Japanese patent application publication No. 2000-179626 and from the European patent application EP-A-0626526 in the name of Applicant. This known belt is often referred to as a push belt and typically includes two parallel ring sets, which ring sets are each composed of a number of mutually concentrically nested flexible metal rings, and a number of transverse elements that are mounted on the ring sets and form an essentially contiguous row along the circumference thereof. The transverse elements can slide along such circumference of the ring sets, i.e. in the belt's longitudinal or length direction, for transmitting a driving force between the transmission pulleys.

When describing the directions with respect to the drive belt and/or a transverse element thereof, it is always assumed that the transverse element(s) is/are in an upright position, such as is illustrated in FIG. 2 in a front view thereof. In this FIG. 2 the longitudinal or length direction L of the drive belt is at right angles to the plane of the figure. The transverse or width direction W is from left to right and the radial direction R is from top to bottom in the plane of FIG. 2.

A commonly shared design feature of at least the commercially applied push belts is that the transverse elements thereof are each provided with a longitudinally protruding stud on a main face thereof and with a hole on an opposite main face thereof. In the belt, the stud of a transverse element is at least partly inserted in the hole of an adjacent transverse element. The stud and the hole serve to limit a rotation of the transverse elements relative to respectively neighbouring transverse elements, either about an axes oriented transversely to the said length direction, i.e. either an axially oriented axis (i.e. “element pitching”) or about a radially oriented axis (i.e. “element yawing). In addition to limiting rotation of the transverse elements, the mutually engaging stud and hole of two adjacent transverse elements also limit a relative translational movement there between in the said axial and radial directions.

The stud and the hole thus keep the transverse elements to a large extend mutually aligned and, in doing so, prevent belt-internal energy losses and adverse mechanical loading of the transverse elements.

Typically, the stud and the hole are uniformly shaped, e.g. both essentially cylindrically, however, are provided with a slightly different size such that the stud can be inserted in the hole with some clearance in transverse direction, i.e. in a plane that transversely oriented relative to the said longitudinal direction, there between. Such size difference of, or clearance between the stud and the hole is often provided uniformly along the perimeter of the stud, but a varying clearance is in principle also known, for example from the above-mentioned publications. In particular, from EP-A-0626526 it is known to provide a smaller clearance in radial direction, as defined relative to the circular posture of the drive belt as a whole, than in axial direction, to allow adjacent transverse elements to be relatively displaced in that axial direction when crossing from one transmission pulley to the other, and from JP-A-2000-179625 it is known to provide a smaller clearance in radial inward direction than in radial outward direction, to suppress the generation of wear. This latter feature is realised either by offsetting a centreline of the essentially cylindrically shaped stud to the radial inside relative to a centreline of the hole, or by shaping the radial outer half-cylinder part of the stud according to a smaller radius than the radial inner half-cylinder part of the stud.

The stud may also be shaped slightly conical, such that its diameter reduces in its height direction, i.e. in the direction away from the main face whereon it is provided, such as is described in the European patent application EP-A-0329206. This (frusto-)conical shape takes into account a mutual rotation of a pair of adjacent transverse elements about an axis defined on a main face of at least one of the adjacent transverse elements. This latter rotation, of course, allows the drive belt to curve in its length direction, i.e. to form a complete circle and to be wrapped around and between the conical discs of each pulley. Typically, the hole is then also shaped conical, i.e. shaped corresponding to the stud, however, according to a somewhat larger diameter to provide the required transverse clearance there between.

Following the teaching of EP-A-0329206 and given the typical dimensions of the transverse element designs, the cone half-angle of the stud can be calculated to amount to no more than a couple of degrees. Also, according to EP-A-0329206 it is advised to actually add a few degrees to such calculated cone half-angle to account for the slight relative movement in the radial direction that accompanies the said mutual rotation of the said pair of adjacent transverse elements. Thus, in practice, the (frusto-)conical stud is provided with a cone angle of up to 15 degrees.

One place in the transmission where the stud and the hole of adjacent transverse elements mutually physically interact is at the location where the transverse elements leave the pulley. At this location, a transverse element starts to—or at least is inclined to—rotate about is centre of gravity, due to its previous circular motion between the pulley discs. Such rotation, however, is limited—or even inhibited—by the stud of the transverse element hitting the wall of the hole of a respectively preceding transverse element in radial inward direction. A radial inwardly oriented force that is thereby exerted by the stud of the (succeeding) transverse element on the preceding transverse element is, at least eventually by a last transverse element in a string of successive elements, exerted on and counteracted by the ring set. According to the present invention, this sequence of events is principally detrimental to the operation and/or performance of the drive belt, firstly because (rotational) energy is dissipated thereby, thus decreasing the efficiency of the torque transmission between the transmission pulleys, and secondly because the ring set is (additionally) increasingly stressed thereby at the rotational speed of the drive belt increases.

The invention aims to mitigate the above-mentioned detrimental effects and thus to improve the efficiency and/or longevity of the drive belt. In particular according to the invention, by providing the stud and the hole of the transverse elements with a large cone angle as compared with the conventionally applied cone angle, the said force exerted by the stud is increasingly directed in the direction of rotation of the drive belt, instead of radial inwardly. This design feature thus favourably alleviates, the (contact) stress introduced by the transverse elements in the ring set and also—as a consequence and in comparison with the known belt—allows the drive belt to be operated at a higher rotational speed. Moreover, by redirecting the said force in the direction of rotation, i.e. in the length direction of the drive belt, it increasingly and favourably contributes to the forward motion (i.e. in the direction of belt rotation) of the transverse elements.

In a more detailed embodiment of the invention, the cone angle of both the stud and the hole are set to satisfy the mathematical requirement of:

φ2·tan(μₛ)

wherein μₛ represents the (static) coefficient of friction working in the physical contact between the two adjacent transverse elements.

In a sufficiently lubricated transmission, which lubrication is at least required for an all steel drive belt, the said coefficient of friction typically (as, for instance, disclosed in EP-A-0798492) amounts to about 0.17, such that a preferred cone angle of 208 or more is calculated for the stud and the hole. This requirement is introduced in order to ensure that, also when a relative motion between the two adjacent transverse elements is marginal only, the said radial inwardly directed force is split into two force components, whereof one is directed in the direction of rotation, i.e. the length direction of the belt.

The present invention is especially effective in combination with a small transverse (or at least radial inward) clearance between the stud and the hole, because the above-mentioned favourable effects thereof accumulate over the said string of transverse elements. In particular, to reduce the (contact) stress introduced in the ring set, by the transverse elements leaving pulley, to a fraction F of such stress that would be introduced if studs and holes were shaped cylindrically in stead of conically, the following mathematical relation is applicable:

$$F = {[ cos ( \frac{φ}{2} ) ]}^{\frac{Cte - rs}{Cst - ho}}$$

wherein Cte-rs represents a clearance between the transverse elements and the ring set in radial direction and
wherein Cst-ho represents the clearance between the stud and the hole in radial inward direction.

Thus, to realise a significant stress reduction of 25%, i.e. to realise the (contact) stress fraction F of 0.75, and while using a stud with a cone angle of about 40 degrees, the clearance Cst-ho between the stud and the hole in radial inward direction must be 5 times smaller than the clearance Cte-rs between the transverse elements and the ring set in radial direction, since 2·arcos(0.75̂[1/5])=38.58.

The invention will now by way of example be elucidated further along drawing figures in which:

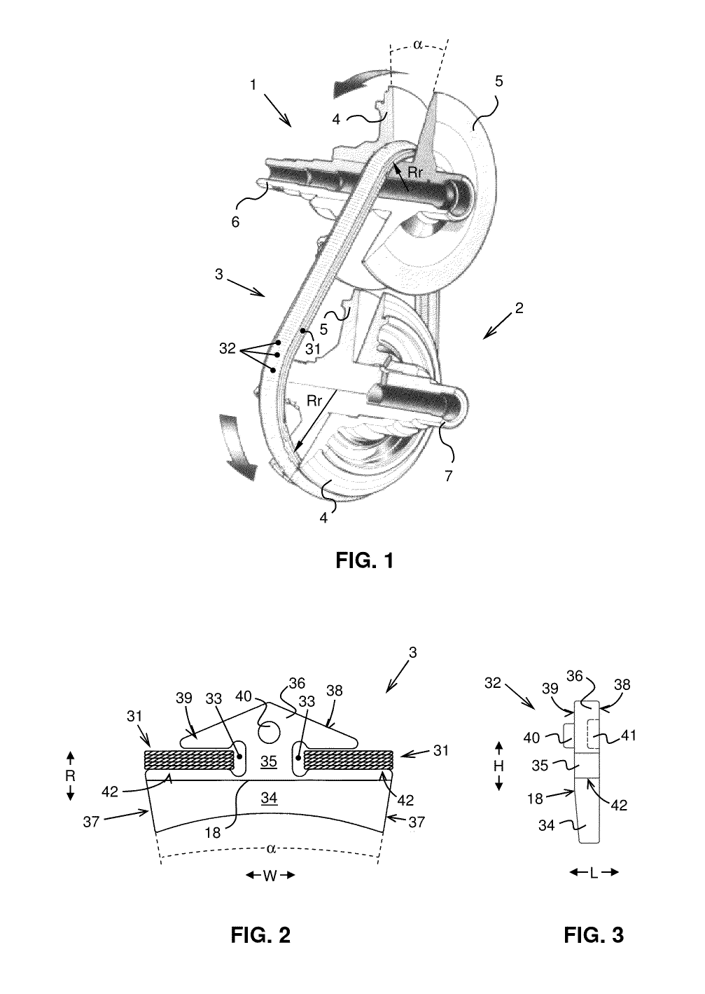

FIG. 1 provides a schematic perspective view of the continuously variable transmission with a drive belt running over two pulleys;

Fig. shows a cross section of the known drive belt viewed in the longitudinal direction thereof;

FIG. 3 provides a width-wise oriented view of a transverse element of the known drive belt;

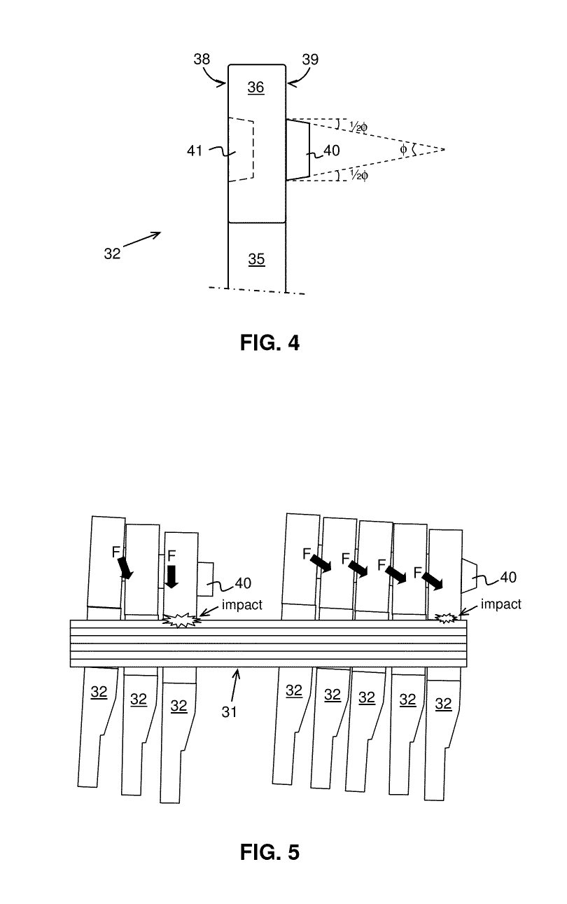

FIG. 4 provides a close-up of a stud of the transverse element in accordance to the present invention; and

FIG. 5 is a graphical illustration of the drive belt behaviour during operation in the transmission that underlies the present invention.

In the figures, identical reference numbers relate to identical, or at least comparable, technical features.

The schematic illustration of a continuously variable transmission in FIG. 1 shows a drive belt 3 which runs over two pulleys 1, 2 and which includes a closed ring set 31 that carries an essentially contiguous row of transverse elements 32 that are arrange over the circumference of the ring set 31. In the illustrated position, the upper pulley 1 rotates more quickly than the lower pulley 2. By changing the distance between the two parts, in this case conical discs 4, 5 from which each pulley 1, 2 is composed, the so-called running radius Rr of the drive belt 3 on the respective pulleys 1, 2 can be changed, as a result of which the speed difference between the two pulleys 1,2 can be varied as desired. This is a known manner of varying a difference in rotational speed between an input shaft 6 and an output shaft 7 of the transmission.

In FIG. 2, the drive belt 3 is shown in a cross section thereof facing in longitudinal direction. This figure shows the presence of two ring sets 31 shown in cross-section that carry and guide the transverse elements 32 of the drive belt 3, whereof one transverse element 32 is shown in front elevation in FIG. 2. The transverse elements 32 and the ring sets 31 of the drive belt 3 are typically made of metal, usually steel. The transverse elements 32 are able to move, i.e. slide along the length direction L of the ring sets 31, so that when a force is transmitted between the transmission pulleys 1, 2, this force is transmitted by the transverse elements 32 pressing against one another and pushing each other forward in a direction of rotation of the drive belt 3 and the pulleys 1, 2.

The ring sets 31 hold the drive belt 3 together and, in this particular exemplary embodiment, are composed of five individual endless rings each, which endless rings are mutually concentrically nested to form the ring set 31. In practice, the ring sets 31 often comprise more than five endless rings, e.g. up to twelve or more.

The transverse element 32, which is also shown in side view in FIG. 3, is provided with two cut-outs 33 located opposite one another and opening towards opposite transverse sides of the element 32. Each cut-out 33 accommodates a respective one of the two ring sets 31. A first or base part 34 of the transverse element 32 thus extending in radial direction R inwards from the ring sets 31, a second or neck part 35 of the transverse element 32 being situated in between and at predominantly the same radial level of the ring sets 31 and a third or head part 36 of the transverse element 32 extending radially outwards the ring sets 31. The lower or radially inward side of a respective cut-out 33 is delimited by a so-called bearing surface 42 of the base part 34 of the transverse element 32, which bearing surface 42 faces radially outwards or upwards in the general direction of the head part 36. The bearing surfaces 42 are typically provided with a convex curvature in the width direction W and/or in the length direction L of the drive belt 3. The radii of curvature associated therewith are typically large in relation to the dimensions of the bearing surfaces 42 and, hence, are not discernable in/on the scale of FIGS. 2 and 3.

The lateral sides or pulley contact surfaces 37 of the said base part 34 of the transverse element 32 are oriented at an angle α with respect to one another, which corresponds, at least predominantly, to a V-angle α defined between the conical discs 4, 5 of the transmission pulleys 1, 2 (see FIG. 1).

A first or rear main face 38 of the transverse element 32 facing in the length direction L of the drive belt 3 is essentially flat, while a so-called rocking or tilting edge 18 is provided on an opposite facing, second or front main face 39 of the transverse element 32. Above the rocking edge 18, the transverse element 32 in side view has an essentially constant thickness and radially inwards from the rocking edge 18, whereas below the rocking edge 18, the said base part 34 tapers towards the bottom side of the transverse element 32. The rocking edge 18 is typically provided in the form of a slightly rounded section of the front main face 39 of the transverse element 32. In the drive belt 3, the front main face 39 of the transverse element 32 arrives in contact with the rear main face 38 of an adjacent transverse element 32 at the location of the rocking edge 18, both in the straight parts of the drive belt 3 stretching between the pulleys 1, 2 and in the curved parts thereof located between the conical pulley discs 4, 5 of the transmission pulleys 1, 2.

The transverse element 32 is further provided with a longitudinally protruding stud 40 on the front main face 39 thereof and with a hole 41 on the opposite, rear main face 38 thereof. In the belt 3, the stud 40 of a transverse element 32 is at least partly inserted in the hole 41 of an adjacent transverse element 32. The stud 40 and the hole 41 thereby serve to limit a rotation of the transverse elements 32 relative to the respectively neighbouring transverse elements 32, as well as limit a relative translational movement there between in the said width direction W and radial direction R.

It is known in the art to provide the stud 40 and the hole 41 with a slightly (frusto-)conical overall shape with a straight cone surface, whereof the cone half-angle is determined by the mutual rotation of a pair of adjacent, contacting transverse elements 32 about the rocking edge 18 of the succeeding transverse element 32 in the drive belt 3, which cone half-angle amounts to a few degrees only. In practice, a (full) cone angle of 15 degrees or less is applied. However, according to the present invention an improvement in the belt design is achieved by applying a larger cone angle φ of 20 degrees or more, as illustrated in FIG. 4.

In FIG. 4 a head part 36 of the transverse element 32 is shown in enlargement. The stud 40 that is provided on and the hole 41 that is provided in this head part 36 of the transverse element 32 have been schematically drawn with an exaggerated cone shape and provided with a cone angle φ. According to the invention this cone angle φ amounts to 208 or more.

In FIG. 5 the presently relevant behaviour of a drive belt 3 is illustrated in a comparison between conventionally designed transverse elements 32 on the left side of this figure and transverse elements 32 designed in accordance with the present invention on the right side thereof. In FIG. 5 the movement of the transverse elements 32 relative to the ring set 31 is shown immediately after the elements 32 leave a pulley 1, 2, i.e. after they have just been released from being clamped between the pulley discs 4, 5. It may be evident that due to the angular momentum that is imparted on the transverse element 32 where it is clamped between the pulley discs 4, 5, the transverse element 32 continues to rotate about an axially oriented axis also after it has left a pulley 1, 2. In this part of the belt's trajectory in the transmission, such rotation will no longer be relative to the respective shaft 5, 6, but rather relative to the centre of gravity of the transverse element 32. This latter rotation, however, is limited—or even inhibited—by the stud 40 of a respectively succeeding transverse element 32 hitting the wall of the hole 41 of a respectively preceding transverse element 32 in radial inward direction. The force F that is thereby exerted by the succeeding transverse element 32 on the preceding transverse element 32 is impacted at least in part—and at least eventually by a last transverse element 32 in a string of successive elements 32—on the ring set 31 in radial inward direction. This radial inward impact on ring set 31 is of course repeated for every transverse element 32 leaving the pulleys 1, 2 and, as consequence, has a significant detrimental effect on the longevity ring set 31 and thus on the service life and/or load carrying capacity of the drive belt 3 as a whole.

As is shown on the left side of FIG. 5, for the conventionally designed transverse element 32 that is provided with a conically shaped stud 40 and hole 41, however, with a comparatively small cone angle φ, such radial inward impact on the ring set 31 is comparatively large and may even closely correspond to the said force F between two successive transverse elements 32.

In contrast with the above and as is shown on the right side of FIG. 5, by providing the transverse elements 32 with a conical stud 40 and hole 41 having a comparatively large cone angle φ, the said force F exerted between two successive transverse elements 32, is (re-)directed towards the length direction L of the drive belt 3, such that the said radial inward impact on the ring set 31 is favourable reduced and the detrimental effect thereof is advantageously mitigated. According to the invention, to effectively reduce the said impact, the cone angle needs to be large enough for overcoming the (static) friction between the successive transverse elements 32, such that a force component of the said force F that is directed in the length direction L of the drive belt 3 is actually able to propel the (preceding) transverse element(s) 32 in that direction. In this latter case, not only the impact on the ring set 31 is favourably reduced, but also the efficiency of the torque transmission between the transmission pulleys 1, 2 may be improved.

Moreover, according to a further aspect of the invention, the above described comparatively large cone angle of the stud 40 and the hole 41 is preferably combined with a comparatively small clearance in radial inward direction between the stud 40 and the hole 41 of the pairs of successive transverse elements 32 in the drive belt. By reducing such clearance it is realised that an increasing number of transverse elements 32 is included in the string of successive elements 32 leaving a pulley 1, 2 and not having arrived in contact with the ring set 31, which aspect of the invention is also illustrated in FIG. 5. Hereby, the effect of the said redirection of the said contact force F between each pair of successive transverse elements 32 is accumulated and, as a consequence, favourably enhanced.

1. Transverse element (32) for a drive belt (3) with an endless carrier (31) and a number of transverse elements (32), which transverse elements (32) are each provided with two main faces (38, 39), where between the transverse element (32) extends in the thickness direction, with a predominantly conical stud (40) provided on a first main face (39) and with a predominantly conical hole (41) provided on a second main face (38), characterized in that, the cone surface of the stud (40) and the cone surface of the hole (41) is oriented at an angle (½φ) of at least 10 degrees relative to a normal of the respective main face (38; 39).

2. Transverse element (32) according to claim 1, characterized in that, the cone angle φ of the conical stud (40) and the cone angle φ of the conical hole (41) are both equal to 20 degrees.

3. Transverse element (32) according to claim 1, characterized in that, the cone angle φ of the conical stud (40) and the cone angle φ of the conical hole (41) are both larger than 20 degrees and, preferably, amount to a value between 25 and 35 degrees.

4. Transverse element (32) according to claim 1, characterized in that, the cone angle φ of the conical stud (40) and the cone angle φ of the conical hole (41) are both equal to two times the tangent of the static coefficient of friction μₛ that is applicable to/in a friction contact between that stud (40) and (the cone surface of) that hole (41).

5. Transverse element (32) according to claim 1, characterized in that, the cone angle φ of the conical stud (40) and the cone angle φ of the conical hole (41) are both larger than two times the tangent of the static coefficient of friction μₛ that is applicable to/in a friction contact between that stud (40) and (the cone surface of) that hole (41).

6. Transverse element (32) according to claim 1, characterized in that, the cone surface of the stud (40) and the cone surface of the hole (41) extend in a predominantly straight line oriented at the said angle (½φ) of at least 10 degrees relative to a normal of the respective main face (38; 39).

7. Drive belt (3) with an endless carrier (31) and a number of transverse elements (32) according to claim 1 that are mounted on the endless carrier (31) in a slideable manner.
